(19) United States
(12) Patent Application Publication
(10) Pub. No.: US 2020/0045928 A1
(43) Pub. Date: Feb. 13, 2020

(54) PET POTTY POD

(71) Applicant: Ryan Venter, Greenwich, CT (US)

(72) Inventor: Ryan Venter, Greenwich, CT (US)

(21) Appl. No.: 16/058,080

(22) Filed: Aug. 8, 2018

(51) Int. Cl. A01K 1/01

(52) U.S. Cl. CPC A01K 1/0114

(57) ABSTRACT

A pet potty pod comprising: a container, where the container includes an opening; a steel mesh covering; and an absorption pad within the container. The container is preferably a rectangular cuboid, where the absorption pad is adapted to receive fluid. The pet potty pod according to claim 1, where the container is a wooden box.

### BACKGROUND OF THE INVENTION

### Field of Invention

The present invention relates to a pet potty pod that is used to allow pets to urinate or defecate.

### Description of Related Art

Many pet owners use potty pads to allow their pets to have an area to urinate or defecate in an indoor environment. These pads are very convenient and once trained pets can use these pads to avoid spreading urine or fecal matter over an indoor environment. However, one drawback to these pads is that pets step into the waste after using the pads and then consequently spread the urine or fecal matter all over the household. Although the pads address the initial collection of waste, the waste may then be spread by the pet and the pads need to be replaced often usually after 2 to 3 uses. Another drawback is the pets play with the potty pads and eat them.

One solution to this problem includes the incorporation of pet litter boxes that include a screen on top to allow the pet to urinate or defecate into the box but this also has drawbacks in that there is occasional splash back or again tracking problems that occur. As a result, it would be advantageous to have a potty pod that included a sufficient mesh topping and allowed the flow of urine through the mesh but avoided splash back. Further, any fecal matter could be maintained on the pod and therefore the pet can avoid spreading fecal matter over the interior of the household. The feces can be removed off the mesh with toilet paper.

### SUMMARY OF THE INVENTION

The present invention relates to a pet potty pod comprising: a modular container, where the container includes an opening; a steel mesh covering; and an absorption pad within the container. The container is preferably a rectangular cuboid, where the absorption pad is adapted to receive fluid. The pet potty pod according to claim 1, where the container is a wooden box.

### BRIEF DESCRIPTION OF DRAWINGS

FIG. 1 depicts the pet potty pod in accordance to the present invention.

### DETAILED DESCRIPTION

The present invention relates to pet potty pod that includes a wooden box with an opening. The opening of the box is covered with a galvanized steel mesh covering that allows for the entry/flow of urine into the box. Within the box an absorbent pad is placed to absorb the urine and waste that travels through the mesh top. The mesh top is of sufficient threading to allow the flow of urine through but avoids any splash back problems that may occur with the prior art. Further the mesh is sufficiently strong to withstand the weight of a pet while using the pod as an area to urinate or defecate.

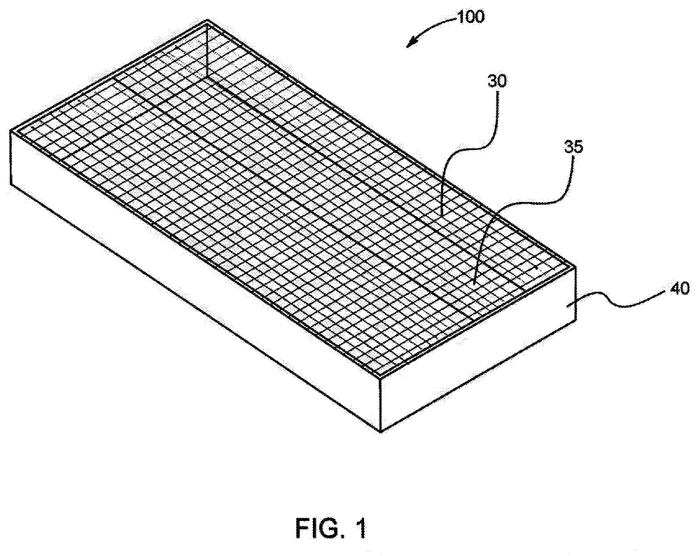

In reference to FIG. 1, a pet potty pod 100 according to the present invention is depicted. The pet potty pod 100 includes a Container 40. As shown the Container 40 is a rectangular cube and may be made of wood, plastic or metal. However, this shape is not limited to this particular configuration as shown in FIG. 1. Other configurations contemplated may include a square cube or oval container with a sufficient covering as shown in FIG. 1. The container 40 has an opening and is covered with a mesh screen 30. The mesh screen 30 allows a transfer of urine through the mesh screen 30 and the collection of the fluid in a pad 35 that is installed within the interior of the container 40. The mesh screen 30 has sufficient strength to provide a stabilize surface for a pet to mount and traverse over the surface while using the pet potty pod 100. Also, the mesh screen 30 is shown in a plain surface, but may be decorated as desired for stylistic purposes.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

1. A pet potty pod comprising:
a. a container, where the container includes an opening;
b. a steel mesh covering; and
c. an absorption pad.

2. The pet potty pod according to claim 1, where the container is a rectangular cuboid.

3. The pet potty pod according to claim 1, where the absorption pad is adapted to receive fluid.

4. The pet potty pod according to claim 1, where the container is a wooden box.
